(19) United States
(12) Patent Application Publication
(10) Pub. No.: US 2026/0249927 A1
(43) Pub. Date: Aug. 27, 2026

(54) VEHICLE COMPONENT AND VEHICLE BODY SUBSTRUCTURE

(71) Applicant: SUBARU CORPORATION, Tokyo (JP)

(72) Inventor: Tomonari NAGASAWA, Tokyo (JP)

(73) Assignee: SUBARU CORPORATION, Tokyo (JP)

(21) Appl. No.: 19/543,533

(22) Filed: Feb. 18, 2026

(30) Foreign Application Priority Data
Feb. 25, 2025 (JP) 2025-027832

(51) Int. Cl. B62D 25/18

(52) U.S. Cl. CPC B62D 25/18

(57) ABSTRACT

A vehicle component that extends along an outer circumference of a wheel includes a groove and a lid member. The groove extends along a longitudinal direction of the vehicle component. The groove faces a ground contact surface of the wheel. The lid member is disposed in an opening of the groove. The lid member covers at least a part of the opening.

### CROSS-REFERENCE TO RELATED APPLICATIONS

The present application claims priority from Japanese Patent Application No. 2025-027832 filed on February 25, 2025, the entire contents of which are hereby incorporated by reference.

### BACKGROUND OF THE INVENTION

### Field of the Invention

The disclosure relates to a vehicle component and a vehicle body substructure.

### Description of Background Art

Japanese Unexamined Patent Application Publication (JP-A) No. 2009-073275 describes a vehicle aerodynamic structure. JP-A No. 2016-124452 describes a vehicle body substructure including a floor under cover and a mudguard. The entire contents of these publications are incorporated herein by reference.

### SUMMARY OF THE INVENTION

According to one aspect of the disclosure, a vehicle component that extends along an outer circumference of a wheel includes a groove and a lid member. The groove extends along a longitudinal direction of the vehicle component. The groove faces a ground contact surface of the wheel. The lid member is disposed in an opening of the groove. The lid member covers at least a part of the opening.

According to another aspect of the disclosure, a vehicle body substructure includes a mudguard extending along an outer circumference of a wheel. The mudguard includes a groove and a lid member. The groove extends along a longitudinal direction of the mudguard. The groove faces a ground contact surface of the wheel. The lid member is disposed in an opening of the groove. The lid member covers at least a part of the opening. The lid member is configured to allow water to enter the groove as the wheel rotates. The lid member is configured to prevent an airflow flowing due to rotation of the wheel from entering the groove.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating a configuration example of a vehicle including vehicle components according to an embodiment of the disclosure;

FIG. 2 is a perspective view of a vehicle component according to an embodiment of the disclosure, as viewed from a bottom surface side of a vehicle body;

FIG. 3 is a cross sectional view of a vicinity of a wheel taken along a front-rear direction when the vehicle components according to an embodiment of the disclosure are mounted;

FIG. 4 is a cross sectional view of the vicinity of the wheel taken along a vehicle width direction when the vehicle components according to an embodiment of the disclosure are mounted;

FIG. 5 is a partial enlarged view of FIG. 4; and

FIG. 6 is a cross sectional view of a groove according to a modified example according to an embodiment of the disclosure taken along the vehicle width direction.

### DETAILED DESCRIPTION OF THE EMBODIEMENTS

Embodiments will now be described with reference to the accompanying drawings, wherein like reference numerals designate corresponding or identical elements throughout the various drawings. Factors including, without limitation, numerical values, shapes, materials,

components, positions of the components, and how the components are coupled to each other are illustrative only and not to be construed as limiting to the disclosure.

In the following, a mudguard extending along an outer circumference of a front wheel of a vehicle will be described as an example of a vehicle component of the disclosure. However, the disclosure is not limited to this example. That is, the vehicle component of the disclosure is a component disposed along the outer circumference of the wheel. Examples of the vehicle component of the disclosure include components called "inner fender", "fender liner", and the like. The wheel where the vehicle component of the disclosure is disposed is not limited to a front wheel. The vehicle component of the disclosure may be disposed on a middle wheel and a rear wheel. In the disclosure, the "water containing a snow melting agent and mud" described above is simply referred to as "muddy water". However, such "muddy water" does not necessarily contain a snow melting agent or mud.

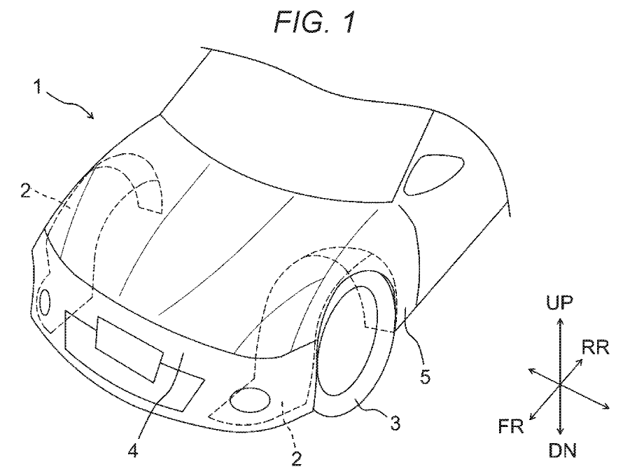

A vehicle component according to an embodiment of the disclosure will be described with reference to FIGS. 1 to 4. As illustrated in FIG. 1, a mudguard 2 that covers a lower outer surface of a vehicle body is fixed to a vehicle body panel of a vehicle 1 so as to face an outer surface (tread portion TS) of a front wheel 3.

The mudguard 2 protects an inside of a tire house from small stones, mud, and the like that are kicked up from the ground by the front wheel 3 during traveling of the vehicle 1. In the present embodiment, the mudguard 2 may be manufactured by blow molding using a synthetic resin material. Examples of the synthetic resin material include materials such as polypropylene, polyethylene, polycarbonate, polyamide, polyethylene terephthalate, and polybutylene terephthalate. The mudguard 2 may be formed by superposing and joining press-molded metal plates or synthetic resin plates.

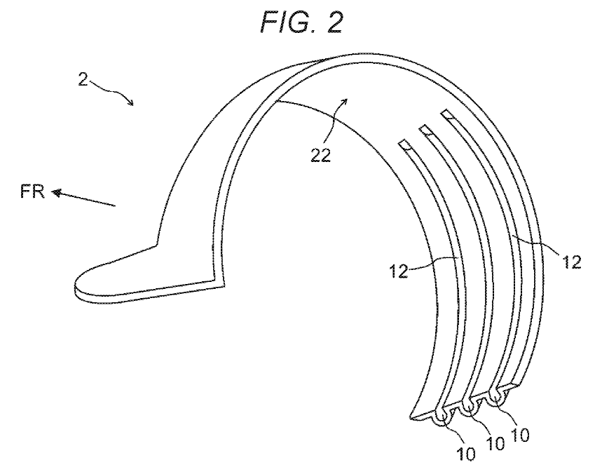

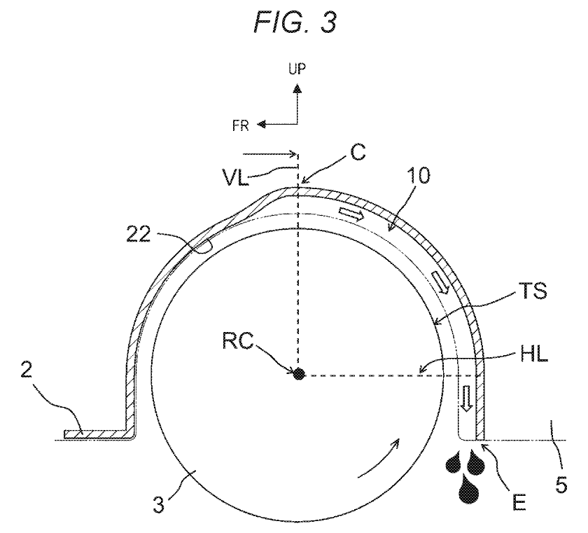

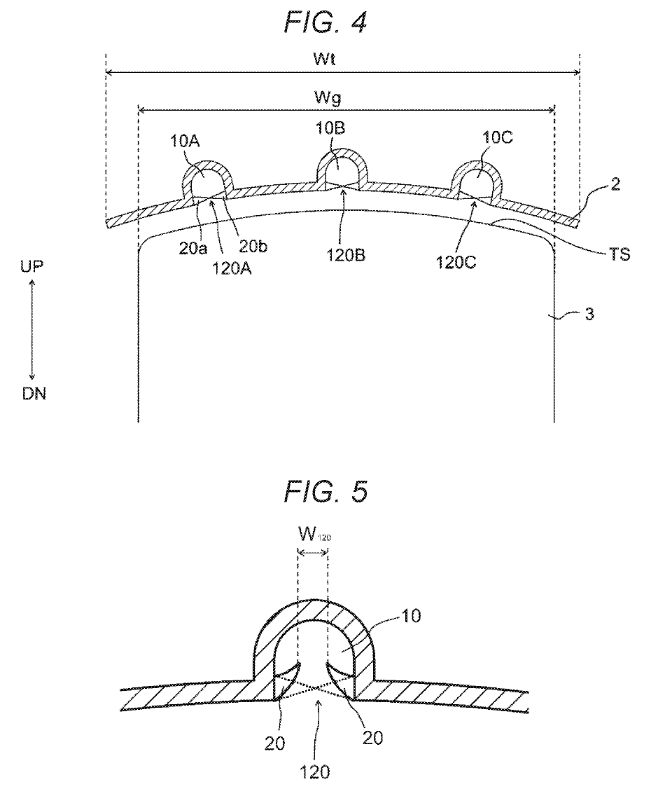

FIG. 2 is a perspective view of the mudguard 2 according to the present embodiment, as viewed from a bottom surface side of the vehicle body. FIG. 3 is a cross sectional view of the vicinity of the wheel in a vehicle front-rear direction when the mudguard 2 according to the present embodiment is mounted. Similarly, FIG. 4 is a cross sectional view of the vicinity of the wheel in a vehicle width direction when the mudguard 2 according to the present embodiment is mounted.

As illustrated in FIGS. 1 and 4, the vehicle on which the mudguards 2 according to the present embodiment are mounted includes a front bumper 4 and front fenders 5. The front bumper 4 is disposed forward of the front wheels 3 and extends in the vehicle width direction. The front fenders 5 extend rearward of the vehicle body from both upper ends of the front bumper 4 in the vehicle width direction beyond above the front wheels 3.

The mudguards 2 are provided behind both sides of the front bumper 4 in the vehicle width direction and below the front fenders 5. The mudguards 2 extend along outer circumferences of the front wheels 3 and form the tire houses. The mudguard 2 has an arc shape in a side view. An outboard end of the mudguard 2 in the vehicle width direction is fastened to a wheel arch portion of the front fender 5 from an inboard side in the vehicle width direction. As illustrated in FIG. 4, a width Wt of the mudguard 2 is wider than a width Wg of the front wheel 3. In other words, the outer circumference of the front wheel 3 is covered by the mudguard 2 from an outboard end of the front wheel 3 in the vehicle width direction to an inboard end of the front wheel 3 in the vehicle width direction.

As illustrated in FIGS. 2 and 4, the mudguard 2 further includes grooves 10 and lid members 20 (for example, 20a and 20b illustrated in FIG. 4). The groove 10 faces an outer circumference surface of the front wheel 3 and extends along a longitudinal direction of the mud guard 2. The lid members 20 are disposed in an opening 12 of the groove 10 and cover the opening 12.

As illustrated in FIG. 2 and the like, the groove 10 is a circumferential groove that opens toward the front wheel 3. In the present embodiment, the grooves 10 are provided at least in a portion overlapping with a rear side of the front wheel 3. For example, in the present embodiment, as illustrated in FIG. 3 and the like, the groove 10 is provided in a part of the mudguard 2 located rearward of a rotation axial line RC (wheel center) of the front wheel 3 and rearward and below a portion C where the mudguard 2 intersects a vertical line VL passing through the rotation axial line RC of the front wheel 3. For example, the groove 10 has an arc shape continuing from the portion C to a portion E at a rear end of the mudguard 2. The groove 10 may smoothly continues to a general wall portion 22 that is a general surface of the mudguard 2, in such a manner that a groove bottom at the portion C serving as a base end is tapered.

In other words, the groove 10 faces the tread portion TS of the front wheel 3. The tread portion TS is a so-called ground contact surface with which a tire comes into contact with a road surface. In the present embodiment, the groove 10 extends along the longitudinal direction of the mudguard 2. The groove 10 does not necessarily have a straight line shape from the portion C to the portion E, but may have, for example, a corrugated shape.

As illustrated in FIG. 4, the groove 10 opens toward the front wheel 3 in a cross sectional view taken along the vehicle width direction. In the present embodiment, multiple (three) of the grooves 10 (10A, 10B, and 10C) are provided in parallel in the vehicle width direction of the mudguard 2. As the front wheel 3 rotates, these grooves 10 guide the airflow and muddy water flowing along an inner circumference of the mudguard 2 so as to flow into the portion C, which is the base end, and be discharged from the portion E, which is a terminal end. In FIG. 4, the groove has a semicircular shape in the cross sectional view taken along the vehicle width direction. However, the groove is not limited to this shape. The groove may have a rectangular or triangular shape in the cross sectional view taken along the vehicle width direction. In FIG. 4, three grooves 10 are provided, but the number of the grooves 10 may be appropriately set. That is, one or two grooves 10 may be provided at any position, or four or more grooves 10 may be provided.

As illustrated in FIGS. 2 and 4, the lid members 20 are disposed in a vicinity of the opening 12 of the groove 10 so as to cover at least a part of the opening 12. For example, as illustrated in FIG. 4, the lid member 20a protrudes from one end of the opening 12, and the lid member 20b protrudes from the other end so as to face the lid member 20a. In FIG. 4, the lid member 20a and the lid member 20b are disposed such that tip ends of the lid member 20a and the lid member 20b are just in contact with each other, and a slit 120A is provided between the lid member 20a and the lid member 20b. Here, since the slit 120A is normally provided without a gap, an inside of the groove 10A is not visible from the outside of the slit 120A. However, the present embodiment is not limited to the above-described structure. The tip portions of the lid member 20a and the lid member 20b may not be in contact with each other. That is, in the present embodiment, at least a part of the opening 12 of the groove 10 may be simply covered with the lid members 20 protruding from both sides of the opening 12. The lid members 20 may have the slit 120 (120A, 120B, and 120C) extending along the longitudinal direction of the mudguard 2. The slit 120 may be provided as a gap. Alternatively, the slit 120 may be provided without a gap in a normal state.

In the present embodiment, the lid member 20 may be made of an elastic member. In one embodiment, the elastic member serves as a first elastic member. For example, the lid member 20 may be made of a material having a higher elasticity than that of the mudguard 2. For example, the lid member 20 may be made of a material having an elasticity. Examples of the material include rubber, resin, and elastomer. The lid member 20 is coupled to an end of the opening 12 in a known manner. For example, the lid member 20 may be fixed to the end of the opening 12 by a method such as an adhesive or may be fastened to the end of the opening 12 by screwing or the like. Alternatively, the lid member 20 may be welded to the end of the opening 12 by a method such as thermocompression bonding. In the disclosure, the "end of the opening" may be the outermost edge of the opening. However, the disclosure is not limited thereto. As long as the lid members 20 can cause muddy water to stay in the groove 10, the lid members 20 may be attached at positions offset from the outermost edge of the opening 12 toward a bottom of the groove 10.

With the above-described configuration, the following effects can be obtained. That is, the muddy water that is kicked up by the rotation of the front wheel 3 hits an inside of the mudguard 2. At this time, the lid members 20 made of the elastic member are pushed up by an impact of the hitting muddy water (see a solid line portion in FIG. 5). As a result, the lid members 20 are elastically deformed, such that a width W₁₂₀ of the gap of the slit 120 is widened to allow the muddy water to pass through the slit 120 and enter the groove 10. That is, the lid members 20 according to the present embodiment allow the muddy water to pass therethrough into the groove 10.

As described above, since the lid members 20 are made of the elastic member, the width of the expanded slit 120 returns to the original width after the muddy water passes therethrough (see a dotted line portion in FIG. 5), and the muddy water having entered the groove 10 stays in the groove 10. The muddy water in the groove 10 moves in a direction of the portion E at the rear end of the mudguard 2 in accordance with the gravity (outlined arrow in FIG. 3) and is discharged outside the vehicle from a mudguard terminal end. That is, it can be said that the lid members 20 cause the muddy water to stay in the groove 10. The lid members 20 rectify the airflow generated in the wheel house by the rotation of the front wheel 3 and prevent an influence exerted by the groove 10 on aerodynamics.

Although an embodiment of the disclosure has been described in detail above with reference to the accompanying drawings, the disclosure is not limited to the embodiment. For example, a position and shape of each element may be appropriately changed as long as the above-described effects can be achieved.

### First Modified Example

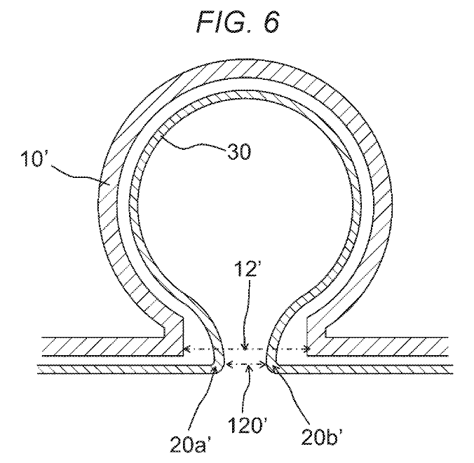

A modified example of the disclosure will now be described with reference to FIG. 6. As illustrated in FIG. 6, a vehicle component according to the present modified example differs from the above-described embodiment in the configuration of the groove 10. Therefore, in the following, this difference will be mainly described, and common reference signs are given to the same points as those of the embodiment, and description thereof will be omitted.

As illustrated in FIG. 6, a groove 10' according to the modified example has an Ω (omega) shape in the cross sectional view taken along the vehicle width direction, and has an opening 12' toward the front wheel 3 side. Lid members 20' (20a' and 20b') of the modified example include a liner 30. At least a part of the liner 30 is inserted into the groove 10'. The liner 30 covers an inner surface of the groove 10'. In other words, the liner 30 is continuous with the lid member 20a' and the lid member 20b', which protrude so as to face each other. A slit 120' having a width narrower than that of the opening 12' is provided between the lid member 20a' and the lid member 20b'.

In the present modified example, the liner 30 may be made of an elastic member. In one embodiment, the elastic member serves as a second elastic member. The liner 30 may be made of an elastic member of the same type as the lid member 20', or may be made of an elastic member of a different type. That is, in the present modified example, the lid member 20' is continuous with the liner 30, is inserted into the groove, and has an elastic force. Thus, a shape of the lid member 20' can be maintained. In the present modified example, the lid members 20' are not directly coupled to the end of the opening 12', but the lid members 20' achieve both of (i) allowing water to pass through the slit 120' into the groove 10' and (ii) causing muddy water to stay in the groove 10'.

According to an embodiment of the disclosure, when the vehicle travels on a road on which snow has fallen or the like, contamination of the vicinity of the vehicle side door due to a kicking up phenomenon of muddy water is prevented.

There has been proposed a structure in a vicinity of a wheel for a purpose of, for example, rectifying an airflow generated in a wheel house in accordance with rotation of the wheel.

For example, Japanese Unexamined Patent Application Publication (JP-A) No. 2009-073275 describes a vehicle aerodynamic structure. The vehicle aerodynamic structure includes an airflow hitting wall and an air guiding wall. The airflow hitting wall is provided forward or rearward, in a front-rear direction of a vehicle body, of a wheel in a wheel house. The airflow hitting wall extends in a vehicle width direction. The airflow hitting wall faces downward in an up-down direction of the vehicle body. The air guiding wall extends downward in the up-down direction of the vehicle body, from an end of the airflow hitting wall at a side far from the wheel. The airflow guiding wall extends in the up-down direction of the vehicle body or extends so as to face toward the wheel and downward in the up-down direction of the vehicle body.

JP-A No. 2016-124452 describes a vehicle body substructure including a floor under cover and a mudguard. The floor under cover covers a lower surface of a vehicle body behind a wheel. The mudguard extends along an outer circumference of the wheel to form a tire house. The mudguard includes a water drain portion, a rectifying portion, and a connection portion. The water drain portion couples an outboard portion, in the vehicle width direction, of a rear lower end of the mudguard and the floor under cover. The rectifying portion couples an inboard portion, in a vehicle width direction, of the rear lower end of the mudguard and a lower surface of the floor under cover. The connection portion connects an inboard end, in the vehicle width direction, of the water drain portion and an outboard end, in the vehicle width direction, of the rectifying portion. The water drain portion has an arc shape in a side view. The rectifying portion has an arc shape having a curvature radius larger than that of the water drain portion in the side view. The connection portion has an arc shape having a curvature radius increasing toward an inboard side in the vehicle width direction in the side view.

When a vehicle travels on a road surface on which snow has fallen or the like, wheels sometimes kick up water containing a snow melting agent and mud on the road surface (hereinafter, referred to simply as "muddy water"), which may get an outer handle of a side door or the like dirty. It is understood that this phenomenon is caused as follows: the muddy water splashed by the wheels hits a wall inside a wheel arch once, and when the muddy water rebounds toward the outside of the vehicle and is discharged to the outside, the muddy water is caused to flow rearward by travel wind.

In the related art including the Publications described above, it has not been possible to reduce vehicle contamination caused by such splashing up and kicking up. It is desirable to provide a technique of preventing contamination in a vicinity of a side door of a vehicle due to kicking up of muddy water during traveling on a road on which snow has fallen or the like.

Obviously, numerous modifications and variations of the present invention are possible in light of the above teachings. It is therefore to be understood that within the scope of the appended claims, the invention may be practiced otherwise than as specifically described herein.

1. A vehicle component, comprising:
a vehicle component having a groove extending along a longitudinal direction of the vehicle component; and
a lid member positioned in an opening of the groove of the vehicle component such that the lid member covers at least a part of the opening of the groove of the vehicle component,
wherein the vehicle component is configured to extend along an outer circumference of a wheel such that the groove is configured to face a ground contact surface of the wheel.

2. The vehicle component according to claim 1, wherein the lid member comprises a first elastic member having a slit configured to allow water to pass therethrough into the groove.

3. The vehicle component according to claim 2, wherein the lid member further comprises a second elastic member continuous with the slit of the first elastic member, and at least a part of the second elastic member is inserted into the groove of the vehicle component.

4. The vehicle component according to claim 2, wherein the first elastic member is coupled to an end of the opening of the groove of the vehicle component.

5. The vehicle component according to claim 3, wherein the first elastic member is coupled to an end of the opening of the groove of the vehicle component.

6. A vehicle body substructure, comprising:
a mudguard extending along an outer circumference of a wheel and having a groove extending along a longitudinal direction of the mudguard such that the groove is facing a ground contact surface of the wheel,
wherein the mudguard includes a lid member positioned in an opening of the groove such that the lid member is covering at least a part of the opening, the lid member is configured to allow water to enter the groove as the wheel rotates and prevent an airflow flowing due to rotation of the wheel from entering the groove.

7. The vehicle body structure according to claim 6, wherein the lid member comprises a first elastic member having a slit configured to allow water to pass therethrough into the groove.

8. The vehicle body structure according to claim 7, wherein the lid member further comprises a second elastic member continuous with the slit of the first elastic member, and at least a part of the second elastic member is inserted into the groove.

9. The vehicle body structure according to claim 7, wherein the first elastic member is coupled to an end of the opening of the groove.

10. The vehicle body structure according to claim 8, wherein the first elastic member is coupled to an end of the opening of the groove.
